(19) United States
(12) Patent Application Publication
(10) Pub. No.: US 2013/0068072 A1
(43) Pub. Date: Mar. 21, 2013

(54) DRIVE TOOL DEVICE HAVING DRIVE HANDLE

(71) Applicants: Yi Chen Li, Taichung (TW); Yu Hui Ho, Taichung (TW)

(72) Inventors: Yi Chen Li, Taichung (TW); Yu Hui Ho, Taichung (TW)

(21) Appl. No.: 13/478,155

(22) Filed: May 23, 2012

(30) Foreign Application Priority Data
Sep. 21, 2011 (TW) 100217631

(51) Int. Cl. B25B 23/16; B25G 1/04

(52) U.S. Cl. 81/177.2; 81/177.1

(57) ABSTRACT

A drive tool device includes a drive shaft having a handle member, and having two stems secured together, the handle member is formed on one of the stems and includes a non-circular cross section and includes a density gradually increased from the one end portion toward the other end portion of the handle member, and includes a center of gravity located closer to the other end portion of the handle member. The drive shaft includes a narrowed neck portion and an inclined surface, and the handle member is formed and located between the narrowed neck portion and the inclined surface of the drive shaft and includes a relatively swelled or protruded or expanded structure.

### BACKGROUND OF THE INVENTION

1. Field of the Invention

The present invention relates to a drive tool device, and more particularly to a drive tool device including a drive handle member for allowing the drive tool device to be easily and readily pivoted or rotated relative to the work piece or the like with the drive handle member and for allowing the user to easily and readily conduct various fastener actuating or driving operations.

2. Description of the Prior Art

Typical drive tool devices comprise a drive shank or drive socket or drive member solidly or pivotally attached or mounted or secured to one end of a drive handle for engaging with tool elements or extensions or fasteners and for allowing the tool elements or extensions or fasteners to be actuated or driven or pivoted or rotated relative to the work piece or the like with the drive member of the drive tool devices.

For example, U.S. Pat. No. 6,260,452 to Yu, and U.S. Pat. No. 6,976,452 to Yu disclose two of the typical drive tool devices each comprising an elongated shaft having a longitudinal bore formed therein for slidably receiving or engaging with a drive member or a drive stem which includes a drive device at one end to receive or engage with a driven element, a socket, a tool element, a tool extension, a fastener, or similar articles.

However, the elongated shaft includes a cylindrical and smooth outer appearance or structure or configuration that may not be firmly held or grasped or gripped by the user and that may not be effectively pivoted or actuated or driven or rotated relative to the work piece or the like with the elongated shaft such that the driven element, socket, tool element, tool extension, fastener, or similar articles may not be solidly and stably or suitably or effectively pivoted or actuated or driven or rotated with the elongated shaft by the user.

The present invention has arisen to mitigate and/or obviate the afore-described disadvantages of the conventional drive tool devices.

### SUMMARY OF THE INVENTION

The primary objective of the present invention is to provide a drive tool device including a drive handle member for allowing the drive tool device to be easily and readily pivoted or rotated relative to the work piece or the like with the drive handle member and for allowing the user to easily and readily conduct various fastener actuating or driving operations.

In accordance with one aspect of the invention, there is provided a drive tool device comprising a drive shaft including a first end portion and a second end portion, and including an engaging member provided on the first end portion thereof, and including an engaging cavity formed in the second end portion thereof, and including a handle member provided on the second end portion thereof, the drive shaft includes a first stem and a second stem secured and coupled together, the handle member is formed and provided on the first stem, and the handle member includes a non-circular cross section, and includes a first end portion and a second end portion, and includes a density gradually increased from the first end portion toward the second end portion of the handle member, and includes a center of gravity located closer to the second end portion of the handle member.

The drive shaft includes a narrowed neck portion formed therein and includes an inclined surface formed therein, and the handle member is formed and located between the narrowed neck portion and the inclined surface of the drive shaft and is relatively swelled relative to the drive shaft.

The handle member includes a number of longitudinal ribs and/or a number of longitudinal slots formed on an outer peripheral portion thereof for forming a serrated or rough outer configuration for the handle member and for allowing the handle member to be firmly held or grasped or gripped by the user.

The second stem of the drive shaft includes a bore formed therein, and a driving shank is slidably received and engaged in the bore of the second stem of the drive shaft and extendible into and out of the second stem of the drive shaft, the engaging member is provided on the driving shank.

The drive shaft includes a non-circular engaging opening formed in the first end portion thereof and communicative with the bore of the second stem of the drive shaft, and the driving shank includes a non-circular cross section for engaging with the non-circular engaging opening of the drive shaft and for guiding and limiting the driving shank to slide relative to the drive shaft and for preventing the driving shank from being rotated relative to the drive shaft.

The driving shank includes a number of depressions formed therein, and the drive shaft includes a detent slidably received and engaged therein and extendible into the bore of the second stem of the drive shaft for selectively engaging with either of the depressions of the driving shank and for adjustably anchoring the driving shank to the drive shaft.

The drive shaft includes a control ferrule slidably received and engaged thereon, and the control ferrule includes an actuating member extended therein for selectively engaging with the detent and forcing the detent to engage with either of the depressions of the driving shank.

The drive shaft includes a spring-biasing member engaged with the control ferrule for biasing and forcing the actuating member of the control ferrule to engage with and detent and then to force the detent to engage with either of the depressions of the driving shank. The drive shaft includes a spring-biasing member engaged with the driving shank for biasing and forcing the driving shank to move outwardly relative to the drive shaft.

The driving shank includes a spring-biased projection disposed therein, and the drive shaft includes a stop for selectively engaging with the spring-biased projection of the driving shank and for limiting the driving shank to slide relative to the drive shaft and for preventing the driving shank from being disengaged from the drive shaft.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a drive tool device in accordance with the present invention;

FIG. 2 is a perspective view of the drive tool device;

FIG. 3 is a side plan schematic view of the drive tool device, in which a portion of the drive tool device has been cut off for showing the inner structure of the drive tool device;

FIG. 4 is a partial side plan schematic view, in which a portion of the drive tool device has been cut off for showing the inner structure of the drive tool device;

FIG. 5 is a cross sectional view of the drive tool device, taken along lines 5-5 of FIG. 4;

FIG. 6 is a partial cross sectional view illustrating the operation of the drive tool device;

FIG. 7 is another partial cross sectional view similar to FIG. 6, illustrating the operation of the drive tool device;

FIG. 8 is a partial exploded view illustrating the formation of the drive tool device;

FIGS. 9, 10, 11 are side plan schematic views illustrating the formation of the drive tool device;

FIGS. 12, 13 are partial exploded view illustrating the formation of the drive tool device; and

FIG. 14 is a further side plan schematic view illustrating the formation of the drive tool device.

### DETAILED DESCRIPTION OF THE PREFERRED EMBODIMENT

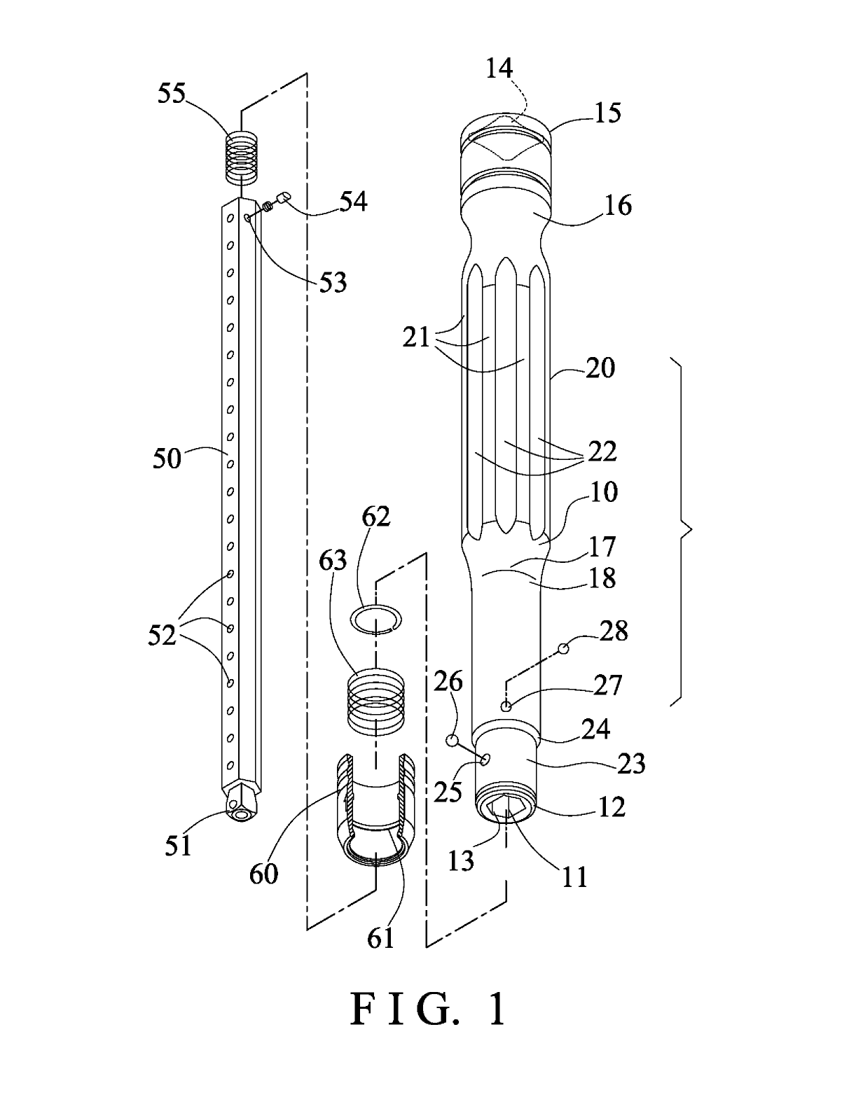

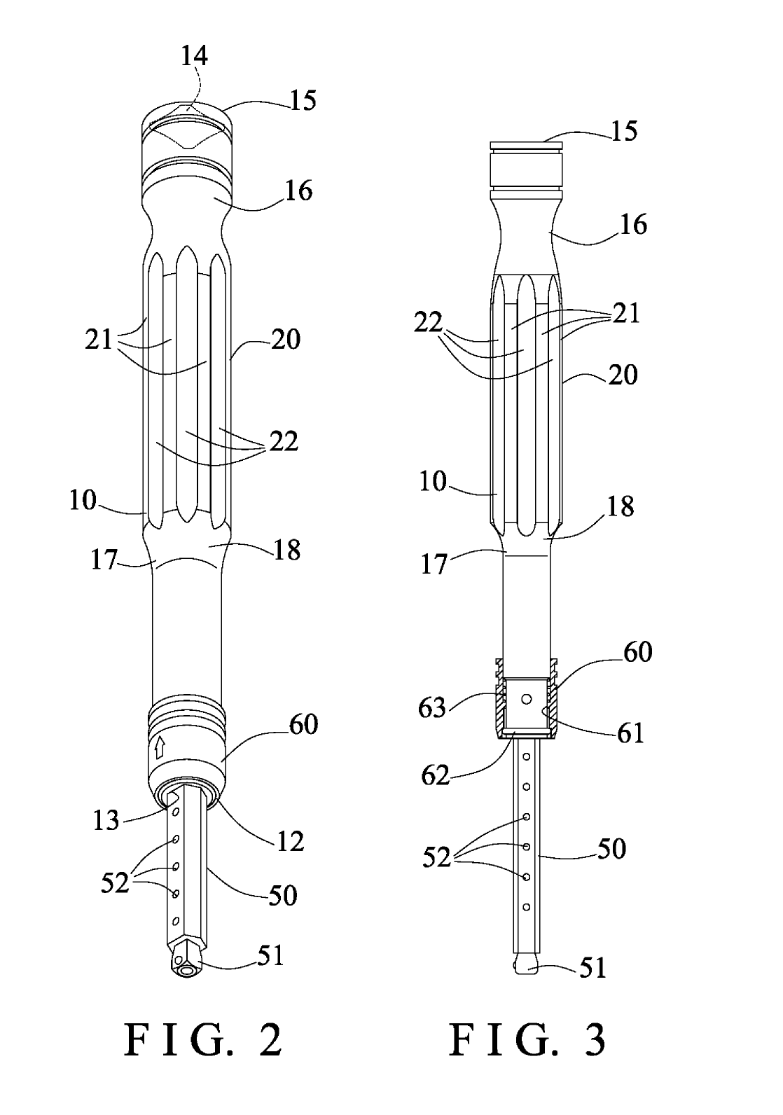

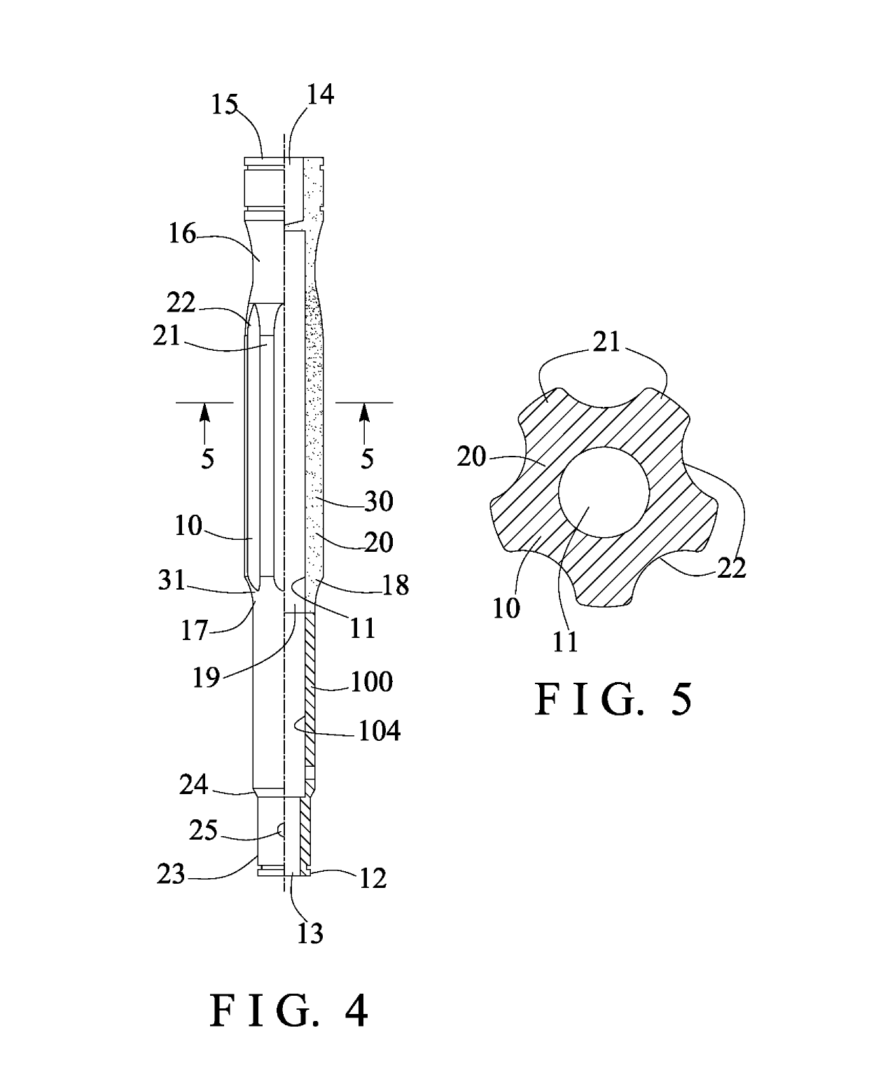

Referring to the drawings, and initially to FIGS. 1-4, a drive tool device in accordance with the present invention comprises an elongated drive handle or shaft 10 including a chamber or notch or space or compartment or bore 11 formed therein (FIG. 4) and opened through one end or first end portion 12 thereof for slidably receiving or engaging with a driving stem or shank 50 and arranged for allowing the driving shank 50 to be selectively extended into or out of the drive shaft 10 (FIGS. 2-3, 6-7). The drive shaft 10 includes a non-circular, such as hexagonal engaging opening 13 formed in the one end portion 12 thereof and communicative with the bore 11 thereof for slidably receiving or engaging with the driving shank 50 that also includes the corresponding non-circular, such as hexagonal cross section for engaging with the non-circular engaging opening 13 of the drive shaft 10 and for guiding and limiting the driving shank 50 to slide relative to the drive shaft 10 only and for preventing the driving shank 50 from being pivoted or rotated relative to the drive shaft 10.

The drive shaft 10 further includes a non-circular, such as quadrilateral or square engaging cavity 14 formed in the other end or second end portion 15 thereof for receiving or engaging with a driving tool 80 (FIG. 7) which may pivot or drive or rotate the drive shaft 10 and the driving shank 50 relative to the work piece 90 or the like. The engaging cavity 14 of the drive shaft 10 may be communicative with or separated from the bore 11 of the drive shaft 10. The drive shaft 10 further includes a narrowed neck portion 16 formed therein and located close to the other end portion 15 thereof, a frustum-shaped or cone-shaped portion or member or tilted or inclined surface 17 formed therein, such as formed in the middle portion 18 thereof for forming or defining a relatively risen or swelled or protruded handle portion or member 20 between the narrowed neck portion 16 and the inclined surface 17 of the drive shaft 10, and one or more longitudinal fins or flanges or ribs 21 and one or more longitudinal grooves or slots 22 formed in the handle member 20 of the drive shaft 10 (FIGS. 1-5), or the handle member 20 of the drive shaft 10 includes a non-circular cross section.

It is to be noted that the formation or the provision of the longitudinal ribs 21 and/or the longitudinal slots 22 in the handle member 20 of the drive shaft 10 allows the handle member 20 of the drive shaft 10 to be firmly held or grasped or gripped by the user and to be effectively pivoted or actuated or driven or rotated relative to the work piece 90 or the like with a suitable friction force. The drive shaft 10 further includes a narrowed neck portion or diameter reduced neck member 23 formed or provided in the one end portion 12 of the drive shaft 10 for forming or defining an outer peripheral shoulder 24 between the diameter reduced neck member 23 and the drive shaft 10, an aperture 25 formed in the neck member 23 of the drive shaft 10 and communicative with the bore 11 and/or the engaging opening 13 of the drive shaft 10 for slidably receiving or engaging with a ball or detent 26 which may be partially extended into the bore 11 and/or the engaging opening 13 of the drive shaft 10. The driving shank 50 includes an engaging member 51 formed or provided on one end or outer end portion and includes a number of depressions 52 formed therein for selectively engaging with the detent 26 which may adjustably anchor or secure or retain the driving shank 50 to the drive shaft 10.

A knob or sleeve or control ferrule 60 is slidably attached or mounted or secured onto the neck member 23 or the one end portion 12 of the drive shaft 10, and includes an actuating member 61 extended therein for selectively engaging with and forcing the detent 26 to engage with either of the depressions 52 of the driving shank 50 and thus for adjustably anchoring or securing or retaining the driving shank 50 to the drive shaft 10 at different or selected position or extension or location. A clamping or anchoring or securing or retaining ring 62 may further be provided and attached or mounted or secured onto the neck member 23 or the one end portion 12 of the drive shaft 10 for selectively engaging with the control ferrule 60 and for guiding and limiting the control ferrule 60 to slide relative to the drive shaft 10 and for preventing the control ferrule 60 from being separated or disengaged from the drive shaft 10 inadvertently. A spring-biasing member 63 is further provided and attached or mounted or secured or disposed or engaged between the control ferrule 60 and the drive shaft 10 for biasing or forcing the actuating member 61 to engage with and detent 26.

In operation, when the control ferrule 60 has not been moved or forced or actuated by the user to move onto and to compress the spring-biasing member 63, the spring-biasing member 63 may bias or force the actuating member 61 to engage with the detent 26 and to move or force the detent 26 to engage with either of the depressions 52 of the driving shank 50 and thus to adjustably anchor or secure or retain the driving shank 50 to the drive shaft 10 at different or selected position or extension or location. The detent 26 may be separated or disengaged from the depressions 52 of the driving shank 50 when the control ferrule 60 is forced or moved onto the spring-biasing member 63 and to compress the spring-biasing member 63 and when the actuating member 61 of the control ferrule 60 is separated or disengaged from the detent 26. The detent 26 may be caused to be engaged with and forced or actuated by the actuating member 61 of the control ferrule 60 and the spring-biasing member 63 again when the control ferrule 60 is released by the user.

The drive shaft 10 further includes an orifice 27 formed in the one end portion 12 thereof (FIG. 1) and offset from the neck member 23 of the drive shaft 10 and communicative with the bore 11 of the drive shaft 10 for slidably receiving or engaging with another ball or detent or stop 28 which may be partially extended into the bore 11 of the drive shaft 10 for selectively engaging with the driving shank 50 and for guiding and limiting the driving shank 50 to slide relative to the drive shaft 10 and for preventing the driving shank 50 from being separated or disengaged from the drive shaft 10 inadvertently. The driving shank 50 includes an orifice 53 formed in an inner end portion thereof for slidably receiving or engaging with a further ball or detent or stop or spring-biased projection 54 which may be selectively engaged with the stop 28 of the drive shaft 10 for guiding and limiting the driving shank 50 to slide relative to the drive shaft 10 and for preventing the driving shank 50 from being separated or disengaged from the drive shaft 10 inadvertently. Another spring-biasing member 55 may further be provided and disposed in the bore 11 of the drive shaft 10 and engaged with the driving shank 50 for biasing or forcing the driving shank 50 to move outwardly relative to the drive shaft 10.

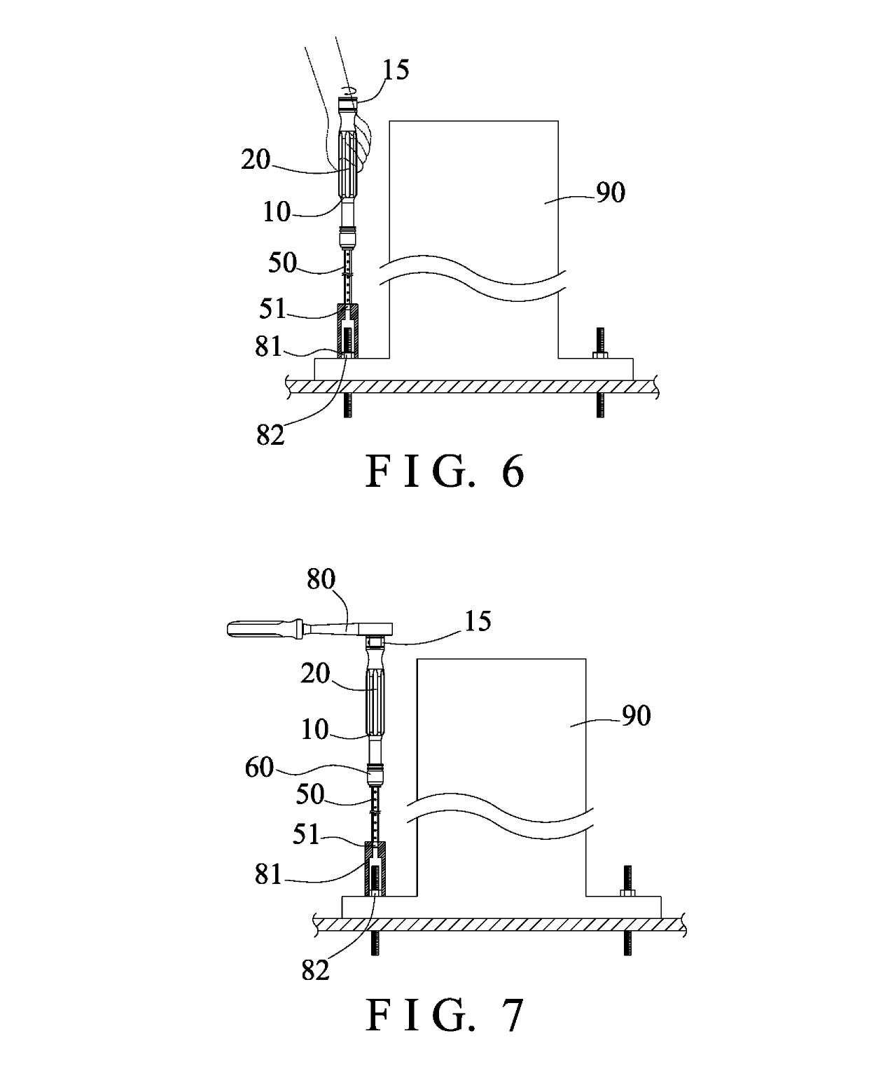

In operation, as shown in FIG. 6, the engaging member 51 of the driving shank 50 may be selectively engaged with a socket or tool extension or driven member 81 which may then be selectively engaged with another driven member or tool element or fastener 82 for allowing the driven member 81 and/or the fastener 82 to be selectively and easily and quickly pivoted or rotated or driven by or with the driving shank 50 and/or the drive shaft 10 by the user with the serrated or rough handle member 20 of the drive shaft 10. As shown in FIG. 7, the driving tool 80 may then be engaged with the engaging cavity 14 of the drive shaft 10 for solidly and stably pivoting or rotating or driving the drive shaft 10 and the driving shank 50 and then the driven member 81 and/or the fastener 82 relative to the work piece 90 or the like. Again, it is to be pointed out that the formation or the provision of the longitudinal ribs 21 and/or the longitudinal slots 22 in the handle member 20 of the drive shaft 10 allows the handle member 20 of the drive shaft 10 to be firmly held or grasped or gripped by the user and to be solidly and stably and effectively pivoted or actuated or driven or rotated relative to the work piece 90 or the like with a suitable friction force.

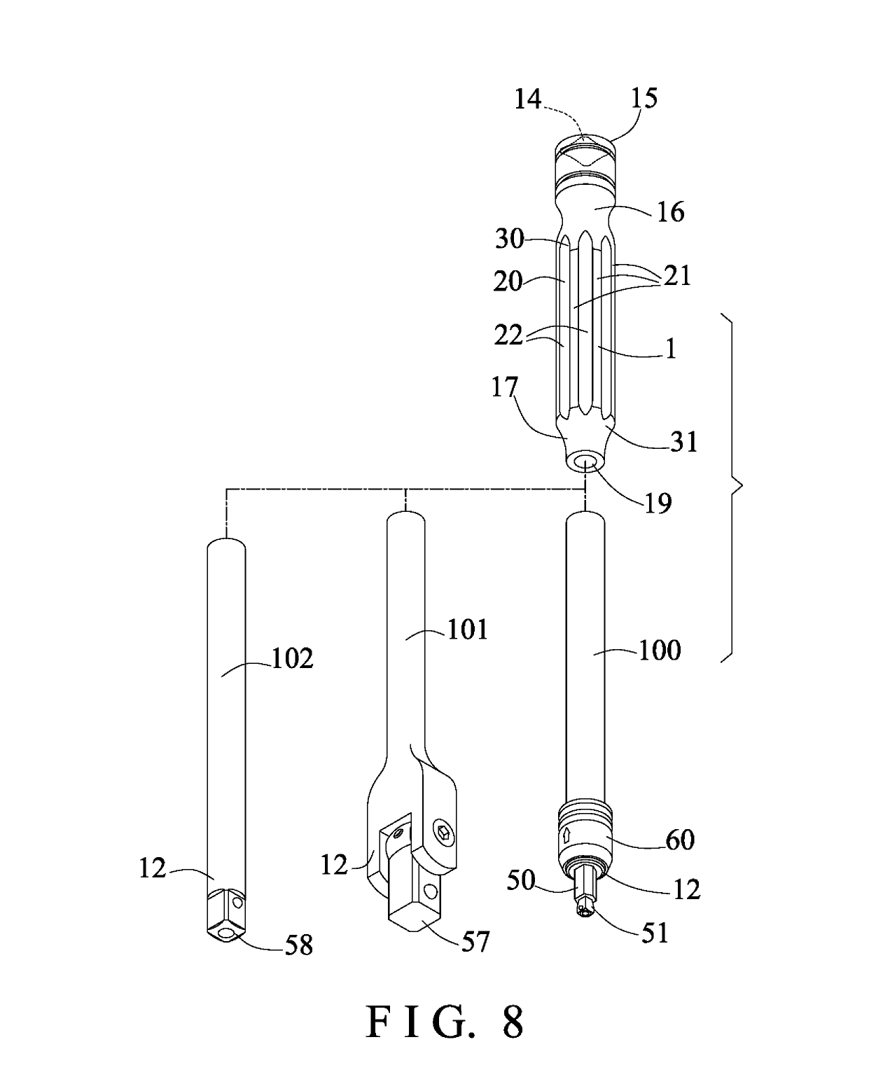

Referring next to FIGS. 8-14, illustrated are the procedures or processes for forming or making or manufacturing the drive shaft 10, as shown in FIG. 8, the drive shaft 10 may include and may be formed with or from a primary or first stem 1 and a secondary or second stem 100, 101, or 102 which may include an engaging member 51, 57, 58 formed or provided on one end or outer end portion 12 thereof for selectively engaging with a socket or tool extension or driven member 81 or the like. The primary or first stem 1 and the secondary or second stem 100, 101, or 102 may be solidly and stably attached or mounted or secured or connected or coupled together by such as ultrasonic welding or other soldering procedures or the like, in which the primary or first stem 1 and the secondary or second stem 100, 101, or 102 may be made of different materials, for example, the primary or first stem 1 may be made of relatively softer or weaker materials, and the secondary or second stem 100, 101, or 102 may be made of relatively harder or solid or stronger materials.

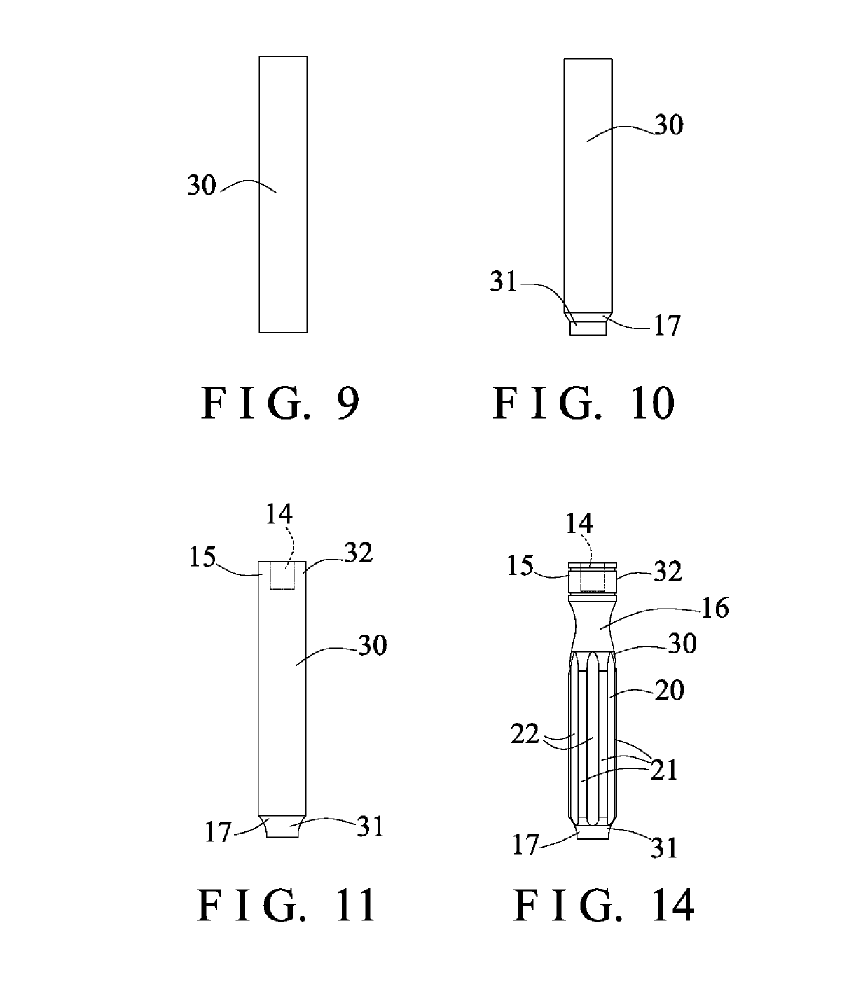

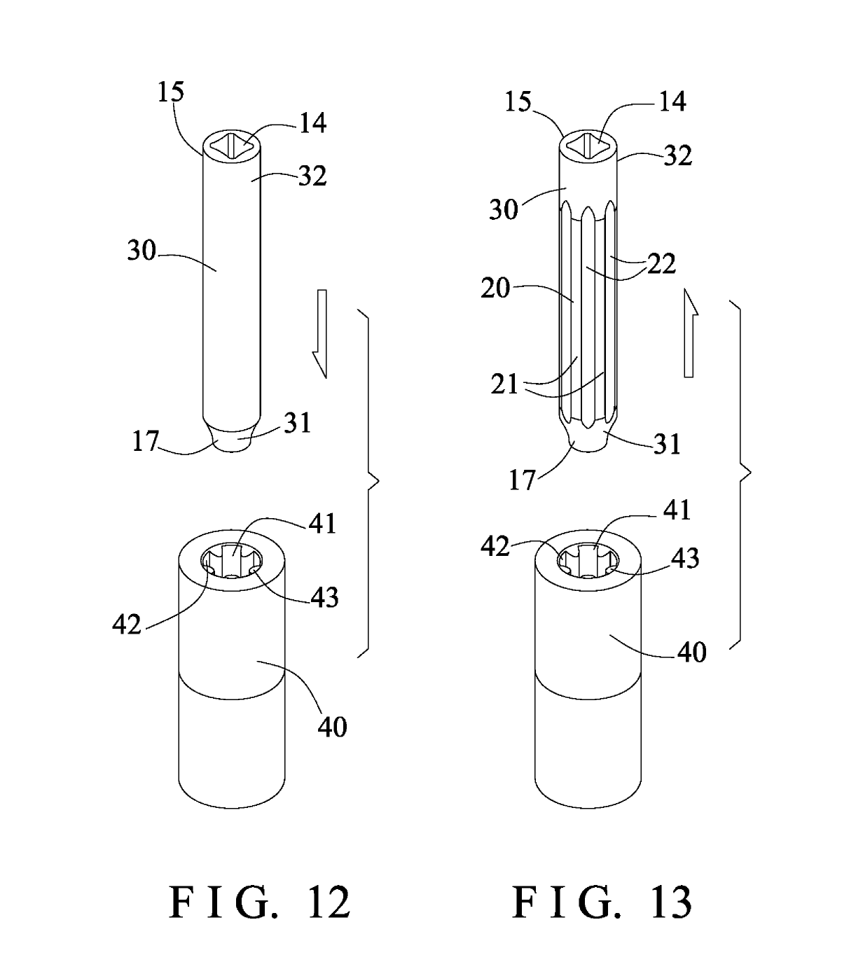

As shown in FIGS. 9-14, the primary or first stem 1 may be made or formed or manufactured from or with a cylindrical member 30 which may then be cut or milled or ground or machined with the inclined surface 17 on one end portion 31 thereof (FIG. 10), and the cylindrical member 30 may then be milled or drilled or machined with the engaging cavity 14 in the other end portion 32 or 15 thereof (FIG. 11), and may then be formed or made or manufactured or machined with the serrated or rough handle member 20 on the outer peripheral portion thereof, best shown in FIGS. 12-13. A mold device 40 is provided for forming or making or manufacturing the handle member 20 on the outer peripheral portion of the cylindrical member 30, and includes a mold cavity 41 formed therein, and includes one or more longitudinal fins or flanges or ribs 42 and one or more longitudinal grooves or slots 43 formed in the mold device 40, or includes one or more longitudinal fins or flanges or ribs 42 extended into the mold cavity 41 of the mold device 40 for forming or defining one or more longitudinal grooves or slots 43 in the mold device 40.

As shown in FIG. 12, the one end portion 31 of the cylindrical member 30 that includes the inclined surface 17 formed therein is forced and fitted or punched or depressed or engaged into the mold cavity 41 of the mold device 40 with pressing or forging machine (not shown) or the like, and then removed or disengaged from the mold device 40 (FIG. 13) for forming or shaping the longitudinal ribs 21 and/or the longitudinal slots 22 and the handle member 20 on or in the outer peripheral portion of the cylindrical member 30 with the longitudinal slots 43 and/or the longitudinal ribs 42 of the mold device 40. The cylindrical member 30 may then be formed or made or shaped or milled or ground or machined with the narrowed neck portion 16 in the other end portion 32 or 15 thereof (FIG. 14) for forming the primary or first stem 1, and the one end portion 31 of the cylindrical member 30 may then be secured or connected or coupled to the secondary or second stem 100, 101, or 102 for forming the drive shaft 10. The cylindrical member 30 may then be formed or milled or drilled or machined with a blind hole 19 in the one end portion 31 of the cylindrical member 30 (FIGS. 4, 8) which is aligned with and communicative with the bore 104 of the secondary or second stem 100, 101, or 102 (FIG. 4) after the primary or first stem 1 and the secondary or second stem 100, 101, or 102 are secured or connected or coupled together.

As shown in FIGS. 12 and 13, when the one end portion 31 of the cylindrical member 30 is forced and fitted or punched or depressed or engaged into the mold cavity 41 of the mold device 40, the materials of the cylindrical member 30 may be depressed or compressed or forged or forced from the one end portion 31 toward the other end portion 32 or 15 of the cylindrical member 30 such that the cylindrical member 30 may include a density gradually increased from the one end portion 31 toward the other end portion 32 or 15 of the cylindrical member 30 or gradually increased from the middle portion 18 of the drive shaft 10 toward the other end or second end portion 15 of the drive shaft 10, and may include a relatively denser other end portion 32 or 15 than the relatively puffy or loosen one end portion 31, as shown in FIG. 4, and such that the cylindrical member 30 may include a center of gravity located closer to the other end portion 32 or 15 thereof. The handle member 20 may thus be easily and quickly and readily formed or made or shaped or machined on the cylindrical member 30 or on the drive shaft 10 with the mold device 40.

Accordingly, the drive tool device in accordance with the present invention includes a drive handle member for allowing the drive tool device to be easily and readily pivoted or rotated relative to the work piece or the like with the drive handle member and for allowing the user to easily and readily conduct various fastener actuating or driving operations.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A drive tool device comprising:
a drive shaft including a first end portion and a second end portion, and including an engaging member provided on said first end portion thereof, and including an engaging cavity formed in said second end portion thereof, and including a handle member provided on said second end portion thereof,
wherein said drive shaft includes a first stem and a second stem secured and coupled together, said handle member is formed and provided on said first stem, and said handle member includes a non-circular cross section, and includes a first end portion and a second end portion, and includes a density gradually increased from said first end portion toward said second end portion of said handle member, and includes a center of gravity located closer to said second end portion of said handle member.

2. The drive tool device as claimed in claim 1, wherein said drive shaft includes a narrowed neck portion formed therein and includes an inclined surface formed therein, and said handle member is formed and located between said narrowed neck portion and said inclined surface of said drive shaft.

3. The drive tool device as claimed in claim 1, wherein said handle member includes a plurality of longitudinal ribs formed on an outer peripheral portion thereof.

4. The drive tool device as claimed in claim 1, wherein said handle member includes a plurality of longitudinal slots formed in an outer peripheral portion thereof.

5. The drive tool device as claimed in claim 1, wherein said second stem of said drive shaft includes a bore formed therein, and a driving shank is slidably received and engaged in said bore of said second stem of said drive shaft and extendible into and out of said second stem of said drive shaft, said engaging member is provided on said driving shank.

6. The drive tool device as claimed in claim 5, wherein said drive shaft includes a non-circular engaging opening formed in said first end portion thereof and communicative with said bore of said second stem of said drive shaft, and said driving shank includes a non-circular cross section for engaging with said non-circular engaging opening of said drive shaft and for guiding and limiting said driving shank to slide relative to said drive shaft and for preventing said driving shank from being rotated relative to said drive shaft.

7. The drive tool device as claimed in claim 5, wherein said driving shank includes a plurality of depressions formed therein, and said drive shaft includes a detent slidably received and engaged therein and extendible into said bore of said second stem of said drive shaft for selectively engaging with either of said depressions of said driving shank and for adjustably anchoring said driving shank to said drive shaft.

8. The drive tool device as claimed in claim 7, wherein said drive shaft includes a control ferrule slidably received and engaged thereon, and said control ferrule includes an actuating member extended therein for selectively engaging with said detent and forcing said detent to engage with either of said depressions of said driving shank.

9. The drive tool device as claimed in claim 8, wherein said drive shaft includes a spring-biasing member engaged with said control ferrule for biasing and forcing said actuating member of said control ferrule to engage with and detent.

10. The drive tool device as claimed in claim 5, wherein said drive shaft includes a spring-biasing member engaged with said driving shank for biasing and forcing said driving shank to move outwardly relative to said drive shaft.

11. The drive tool device as claimed in claim 5, wherein said driving shank includes a spring-biased projection, and said drive shaft includes a stop for selectively engaging with said spring-biased projection of said driving shank and for preventing said driving shank from being disengaged from said drive shaft.
